(19) United States
(12) Patent Application Publication
(10) Pub. No.: US 2019/0003337 A1
(43) Pub. Date: Jan. 3, 2019

(54) ROTOR ASSEMBLY FOR AN EXHAUST GAS TURBOCHARGER

(71) Applicant: IHI CHARGING SYSTEMS INTERNATIONAL GMBH, Heidelberg (DE)

(72) Inventor: Tino STRAUSS, Heidelberg (DE)

(73) Assignee: IHI CHARGING SYSTEMS INTERNATIONAL GMBH, Heideberg (DE)

(21) Appl. No.: 16/101,672

(22) Filed: Aug. 13, 2018

Related U.S. Application Data
(63) Continuation-in-part of application No. PCT/EP2017/000179, filed on Feb. 9, 2017.

(30) Foreign Application Priority Data
Feb. 23, 2016 (DE) 10 2016 103 115.1

(51) Int. Cl. F01D 25/18; F04D 29/12

(52) U.S. Cl. CPC F01D 25/183; F04D 29/122; F05D 2220/40; F05D 2240/60; F05D 2240/55; F05D 2240/50; F05D 2230/13

(57) ABSTRACT

In a rotary assembly for an exhaust gas turbocharger, with a turbine wheel, a compressor wheel which is non-rotatably connected with the turbine wheel by means of a shaft, and an intermediate component of the rotary assembly, which is arranged on the shaft between the compressor wheel and the turbine wheel, at least one of the surfaces of the intermediate component and at least one of a third surface of the compressor wheel and a fourth surface of the shaft comprises projections which are harder than a base of the surface arranged on the opposite side with which they are engaged thereby to increase a permissible operating torque of the exhaust gas turbocharger.

This is a continuation-in-part application of pending international patent application PCT/EP2017/000179 filed 2017 Feb. 9 and claiming the priority of German patent application 10 2016 103 115.1 filed 2016 Feb. 23.

### BACKGROUND OF THE INVENTION

The invention relates to a rotor assembly for an exhaust gas turbocharger with a turbine wheel, a compressor wheel connected to the turbine wheel via a shaft and an intermediate component arranged on the shaft between the compressor wheel and the turbine wheel.

Rotary assemblies for exhaust gas turbochargers are known. The rotary assembly comprises a turbine wheel arranged in a through-flow exhaust gas guide section of the exhaust gas turbocharger and a compressor wheel arranged in a through-flow air guide section of the exhaust gas turbocharger. The turbine wheel and the compressor wheel are non-rotatably connected with each other by means of a shaft which is rotatably supported in a bearing section of the exhaust gas turbocharger. Additional intermediate components may be arranged between the compressor wheel and the turbine wheel.

In order to prevent lubricant leaking from the bearing section from entering the air guide section, a so-called oil slinger ring is provided which is arranged at a wheel rear side of the compressor wheel. The oil slinger ring is formed coaxially on the shaft. A non-rotatable connection of the components is achieved by means of a locking element which is connected with the shaft in a force-locking and form-locking manner at an end of the compressor wheel facing away from the wheel rear side. Normally, the locking element is in the form of a nut.

It is the principal object of the present invention to provide an improved rotary assembly for an exhaust gas turbocharger.

### SUMMARY OF THE INVENTION

In a rotary assembly for an exhaust gas turbocharger, with a turbine wheel, a compressor wheel which is non-rotatably connected with the turbine wheel by means of a shaft, and an intermediate component of the rotary assembly, which is arranged on the shaft between the compressor wheel and the turbine wheel, at least one of the surfaces of the intermediate component and at least one of a third surface of the compressor wheel and a fourth surface of the shaft comprises projections which are harder than a base of the surface arranged on the opposite side with which they are engaged thereby to increase a permissible operating torque of the exhaust gas turbocharger.

In a rotary assembly for an exhaust gas turbocharger, with a turbine wheel, a compressor wheel which is non-rotatably connected with the turbine wheel by means of a shaft, and an intermediate component of the rotary assembly, which is arranged on the shaft between the compressor wheel and the turbine wheel, at least one of the surfaces of the intermediate component and at least one of a third surface of the compressor wheel and a fourth surface of the shaft comprises projections which are harder than a base of the surface arranged on the opposite side with which they are engaged thereby to increase a permissible operating torque of the exhaust gas turbocharger.

The inventive rotary assembly for an exhaust gas turbocharger comprises a turbine wheel, a compressor wheel which is non-rotatably connected with the turbine wheel by means of a shaft, and an intermediate component which is arranged on the shaft between the compressor wheel and the turbine wheel. In order to increase a permissible operating torque of the exhaust gas turbocharger, at least one of the surfaces of the intermediate component and/or a third surface of the compressor wheel and/or a fourth surface of the shaft comprises axial projections which are harder than a base of surface arranged on the opposite side. This is advantageous in that the permissible operating torque of the exhaust gas turbocharger may be increased in a simple manner without an expensive modification of component geometries or a cost-increasing use of other materials which exhibit a high or higher, respective, strength compared to the state of the art.

This means in other words that, for a rotary assembly according to the state of the art, either the used materials must exhibit higher strength values than to date, and/or interfaces between the components of the rotary assembly would have to be enlarged for an increase of a permissible operating torque of the rotary assembly to allow an increase of an axial force of the form-locking and force-locking connection without damage to transmit the required operating torque of the components with lower friction coefficients.

In a particular embodiment, projections are made by means of a laser. This allows to specifically realize fine elevations and corresponding surface structures.

Further features, advantages and details of the invention will become more readily apparent from the following description of preferred exemplary embodiments with reference to the accompanying drawing. The above mentioned features and feature combinations in the description of the figures as well as the following features and feature combinations in the description of the figures and/or shown in the figures alone are not only applicable in the indicated combination but also in other combinations or alone, without deviating from the scope of the invention.

### BRIEF DESCRIPTION OF THE DRAWING

The single FIGURE shows in a longitudinal section a cut-out of a rotary assembly for an exhaust gas turbocharger in the area of a compressor wheel of the rotary assembly.

### DESCRIPTION OF PARTICULAR EMBODIMENTS

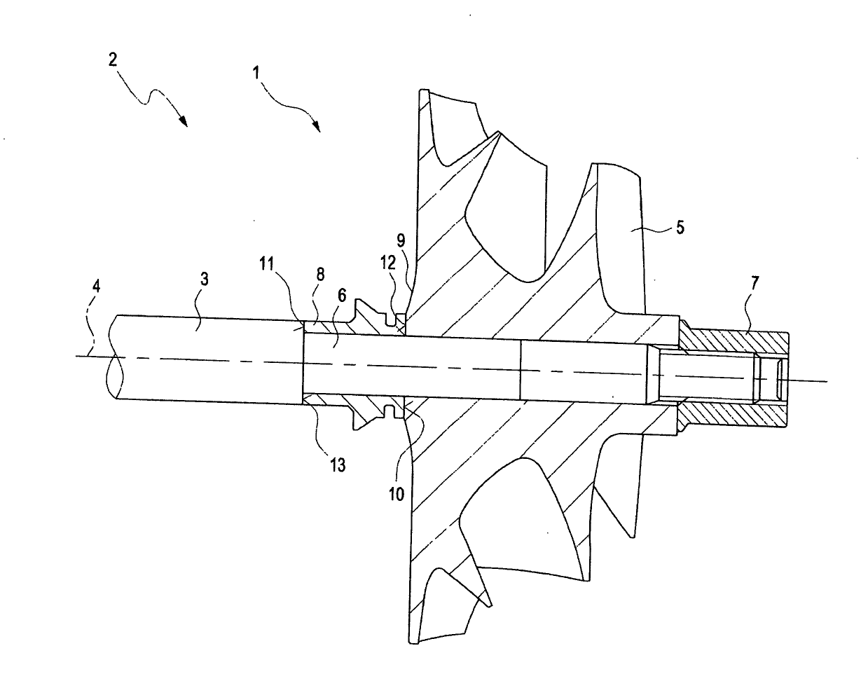

FIG. 1 shows, in a longitudinal section, a cut-out of a rotary assembly 1 for an exhaust gas turbocharger 2. The rotary assembly 1 comprises a shaft 3 as well as a turbine wheel (not shown in detail). The turbine wheel is at least partially to be accommodated in a compartment of a through-flow exhaust gas guide section (not shown in detail) of the exhaust gas turbocharger. The exhaust gas guide section comprises at least one supply duct (not shown in detail), via which exhaust gas of the combustion engine may be supplied to the compartment and thus flows to the turbine wheel. The turbine may be e. g. a radial turbine, wherein the exhaust gas flows to the turbine wheel at least essentially in the radial direction and impinges on it. Caused by the impingement of the exhaust gas on the turbine wheel, the turbine wheel rotates and with it the entire rotary assembly 1 about an axis of rotation 4. The turbine wheel could also be a turbine wheel of a so-called mixed-flow turbine, wherein in the case of a mixed-flow turbine, the incoming flow may impinge on the turbine wheel radially as well as semi-axially or axially.

The shaft 3 is at least mainly disposed in a bearing housing (not shown in detail) of the exhaust gas turbocharger and rotatably supported about the axis of rotation 4 relative to the bearing housing by means of a bearing device (not shown in detail). For driving the rotary assembly 1, the turbine wheel is non-rotatably connected with the shaft 3.

A compressor wheel 5 of an air guide section (not shown in detail) of the exhaust gas turbocharger is non-rotatably connected with the shaft 3, so that the compressor wheel 5 is driven via the turbine wheel by means of the shaft 3. Air to be supplied to the combustion engine may thus be compressed by means of the compressor wheel 5, so that the combustion engine may be operated particularly efficiently.

The compressor wheel 5 is non-rotatably connected with the turbine wheel by means of a force-locking and form-locking connection. Generally, the shaft 3 is formed integrally with the turbine wheel. To obtain the non-rotatable connection, the compressor wheel 5 is slipped onto the shaft 3 which has a smaller diameter in the shaft section 6 formed for accommodating the compressor wheel 5 than in the remaining area, and is clamped with the turbine wheel by means of a locking element 7, generally in the form of a nut.

Generally, at least one intermediate component 8 is arranged between the turbine wheel and the compressor wheel 5. In the illustrated exemplary embodiment, the intermediate component 8 is formed as an oil slinger ring. However, it could also be configured as an axial bearing, or the two components could be clamped between the turbine wheel and the compressor wheel, respectively.

In order to prevent lubricant leaking from the bearing section from penetrating into the air guide section, the so-called oil slinger ring 8 is provided which is arranged at a wheel rear side 9 of the compressor wheel 5. The oil slinger ring 8 is formed on the shaft 3, i. e. surrounding it, and extending coaxially with it.

During operation of the exhaust gas turbocharger, the rotary assembly 1 rotates at very high speeds, and these may result in a relative movement between the individual components of the rotary assembly 3, 5, 8, if an operating torque exceeds a clamping torque of the rotary assembly 1.

For increasing a permissible operating torque, a first surface 10 in the form of an annular surface 10 of the oil slinger ring 8 is provided with a surface structure which increases the surface roughness of the first annular surface 10 and exhibits a higher strength. In other words this means that the first annular surface 10 comprises axial projections which are harder than a base on which the projections are formed. Thus, the first annular surface 10 comprises a surface on the base of which elevations are formed which are harder than the base itself. This may be achieved in various ways, e. g. by means of a metal-cutting method. Preferably, the elevations are formed by means of a laser by laser structuring.

To further increase the permissible operating torque, additional surfaces, a second surface 11 in the form of an annular surface of the oil slinger ring 8, which is formed at the end of the slinger ring 8 facing away from the first annular surface 10, or at a third surface 12 in contact with the oil slinger ring 8 in the form of an annular surface of the compressor wheel rear side 9. Or a fourth surface 13 in contact with the second annular surface 11 in the form of an annular surface of the shaft 3 may comprise the projections. It is to be noted that the annular surface 10, 11, 12, 13 comprising the projections is arranged opposite an annular surface 12, 13, 10, 11 the base of which is softer than the projections. This makes it possible to press the projections into the base upon clamping the impeller, whereby a form-locking and force-locking connection is achieved.

What is claimed is:

1. A rotary assembly for an exhaust gas turbocharger, with a turbine wheel, a compressor wheel (5) which is non-rotatably connected with the turbine wheel by means of a shaft (3), and an intermediate component (8) of the rotary assembly, which is arranged on the shaft (3) between the compressor wheel (5) and the turbine wheel, wherein,
for increasing a permissible operating torque of the exhaust gas turbocharger (2), at least one of the surfaces (10; 11) of at least one of the intermediate component (8) and a third surface (12) of the compressor wheel (5) or a fourth surface (13) of the shaft (3) comprises projections which are harder than a base of the surface (12; 13; 10; 11) arranged in axial engagement on the opposite side.

2. The rotary assembly according to claim 1, wherein the elevations are made by means of a laser.

3. The rotary assembly according to claim 1, the surface (10; 11; 12; 13) is in the form of an annular surface.

4. The rotary assembly according to claim 1, wherein the intermediate component (8) is one of an oil slinger ring and an axial bearing.
